(19) United States
(12) Patent Application Publication
(10) Pub. No.: US 2013/0032395 A1
(43) Pub. Date: Feb. 7, 2013

(54) WIRE CONNECTOR ASSEMBLY INCLUDING SPLICE ELEMENTS FOR FLUID ENVIRONMENTS AND METHODS OF MAKING SAME

(71) Applicants: ERIC J. SMOLL, FONTANA, CA (US); BAO Q. LE, SANTA ANA, CA (US); FEDERICO KELLENBERGER, TECATE (MX); STEVEN WILLING, ENCINITAS, CA (US)

(72) Inventors: ERIC J. SMOLL, FONTANA, CA (US); BAO Q. LE, SANTA ANA, CA (US); FEDERICO KELLENBERGER, TECATE (MX); STEVEN WILLING, ENCINITAS, CA (US)

(73) Assignee: DELPHI TECHNOLOGIES, INC., TROY, MI (US)

(21) Appl. No.: 13/423,325

(22) Filed: Mar. 19, 2012

Related U.S. Application Data
(60) Provisional application No. 61/514,951, filed on Aug. 4, 2011.

(51) Int. Cl. H02G 3/06; H01R 43/16

(52) U.S. Cl. 174/84 R; 29/874

(57) ABSTRACT

A wire connector assembly includes a connector body and at least one wire arrangement that communicates with the connector body. The wire arrangement includes at least one electrically-conductive element formed of a continuous solid mass of material throughout. The at least one solid mass element defines a plurality of bores in which at least a portion of the solid mass element separates at least one of the bores from the other bores in the plurality of bores. A plurality of wire cables is received in the plurality of bores and respectively electrically and mechanically connected to the solid mass element. The portion, grooves defined along the portion, and O-ring seals surroundingly disposed on the connector body combine to prevent fluid flow through the assembly when the assembly is disposed in a fluid environment. A pair of methods to construct the wire connector assembly are also presented.

### RELATED DOCUMENTS

This application claims priority to provisional application U.S. Ser. No. 61/514,951 filed on Aug. 4, 2011.

### TECHNICAL FIELD

The invention relates to a wire connector assembly, more particularly, a wire feed-thru connector assembly contains provisions that allow use of the wire connector assembly in fluid environments.

### BACKGROUND OF INVENTION

It is known to use electrical feed-thru members to transmit electrical signals across two distinct environments.

Some electrical applications require submersion of the feed-thru members in a fluid environment, albeit a liquid or a non-air gaseous fluid environment. One electrical application that uses feed-thru members includes wire conductors formed with an inner core that has individual wire strands covered by an insulation outer covering that are stripped free of the insulation covering and subsequently tinned with solder. Tinning the wire strands fuses the wire strands together by forming a coat of solder on the wire strands resulting in a single, solid core wire connection. The tinned solid core wire connection creates a dam that acts as a leakage barrier to impede fluid flow into, and through the individual wire strands. The tinned solid core connections of the wire conductors are then overmolded with non-electrically conductive materials to form a molded connector body. The molded connector body is subsequently attached to a support structure within the fluid environment. This current feed-thru design approach has drawbacks. One drawback is that the tinned solid core connection that extends beyond a boundary of the molded body is mechanically more stiff than the remaining wire conductor which reduces the flexibility and a bend radius of the wire conductor at the molded connector boundary which may inhibit a tight routing path needed in some electrical applications. Another drawback is the stiffness and low mechanical strength of the solder material coated on the wire strands that undesirably may cause premature fracturing and eventual breakage of the wire conductor resulting in a broken electrical connection. Electrical components, or devices in electrical communication with a broken feed-thru may undesirably not electrically operate. Yet another drawback may occur if the feed-thru member is exposed to high temperatures in the electrical application. The coating of solder within the individual wire strands may undesirably turn the solder from a solid form back to a liquid form and remelt. The remelted solder may indiscriminately flow in the wire strands and produce undesirable voids or air leak paths in the individual wire strands once the solder returns to solid form. These possible quality defects may allow fluids to undersirably penetrate the electrical feed-thru members and undesirably impair the electrical operation of the feed-thru members and the electrical components in electrical communication with the defective feed-thru member. Yet other known fluid-tight seal configurations rely on gaskets and/or glass-to-metal seals that increase the complexity of the feed-thru member while undesirably adding increased cost.

Thus, what is needed is a robust wire connector assembly that overcomes the abovementioned undesired drawbacks.

### SUMMARY OF THE INVENTION

In accordance with one embodiment of the invention, a wire connector assembly includes a connector body and at least one wire arrangement in communication with the connector body. The wire arrangement includes at least one electrically-conductive element and a plurality of wire cables received by the electrically-conducting element. The at least one electrically-conductive element is formed of a continuous solid mass of material throughout. This at least one solid mass element defines a plurality of bores in which at least a portion of the solid mass element separates at least one of the bores from the other bores in the plurality of bores. The plurality of wire cables are respectively received in the plurality of bores and electrically and mechanically connect to the solid mass element.

In accordance with another embodiments of the invention, methods to fabricate, or construct the wire connector assembly are also presented.

Further features, uses and advantages of the invention will appear more clearly on a reading of the following detailed description of the preferred embodiments of the invention, which is given by way of non-limiting example only and with reference to the accompanying drawings.

### BRIEF DESCRIPTION OF THE DRAWINGS

This invention will be further described with reference to the accompanying drawings in which:

FIG. 1 shows a lawn mower where at least a portion of a wire connector assembly is disposed within a fuel tank of the lawn mower, in accordance with the invention;

FIG. 2 shows the wire connector assembly of FIG. 1 removed from the lawn mower;

FIG. 3 shows a cross section of the wire connector assembly of FIG. 2 along the lines 3-3;

FIG. 4 shows a cross section view of an individual electrically-conductive splice contact element removed from the cross section view of the wire connector assembly of FIG. 3, and details thereof;

FIG. 5 shows an exploded view of wire conductors being received in to the splice contact element of FIG. 4 before the wire conductor assembly of FIG. 2 is constructed, and other details thereof;

FIG. 6 shows a method to construct the wire connector assembly of FIG. 2;

FIG. 7 shows a block diagram of a process flow of aligning splice elements in a fixture that is positioned in a mold to produce the wire connector assembly of FIG. 2;

FIG. 8 shows a wire connector assembly and details thereof, according to an alternate embodiment of the invention;

FIG. 9 shows an electrically-conductive splice contact element in electrical communication with an electrical bus bar with a connector body removed therefrom, according to another alternate embodiment of the invention; and

FIG. 10 shows another method to construct the wire connector assembly, according to a yet another alternate embodiment of the invention.

### DETAILED DESCRIPTION

An electrically-conductive feed-through splice element facilitates electrical transmission of electrical signals electrically connected to the splice element across distinct environments. When a plurality of splice elements are bundled in a feed-through connector body to form a wire connector assembly, a plurality of electrical signals may be carried on a plurality of associated wire cables in electrical connection with their associated splice elements through these various distinct environments to operate electrical components in electrical communication with the wire connector assembly. For example, and of special interest is that the feed-thru connector may provide a bridge for electrical signal transmission from an air environment to a fluid environment. The fluid environment may include a fluid liquid or a non-air gaseous fluid environment.

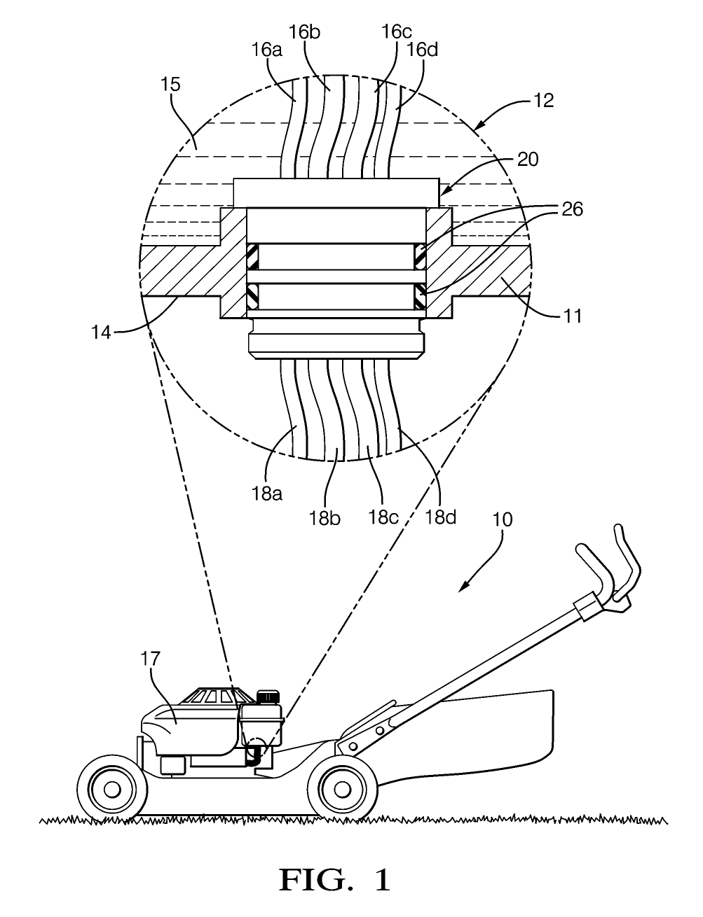

Referring to FIGS. 1-3, a lawn mower 10 includes a wire feed-thru connector assembly 12. Assembly 12 is located within a wall, or bulkhead 11 of a fuel tank 14 of lawn mower 10 and electrically connects one electrical component disposed in fuel tank 14, such as a fuel sensor (not shown) used to measure an amount of liquid fuel 15 in tank 14, to another electrical component (not shown) external to fuel tank 14. Liquid fuel 15 disposed in tank 14 is used to operatively power a fuel combustion engine 17 of lawn mower 10. Thus, assembly 12 as disposed on lawn mower 10 is exposed to an air-only environment along a first portion of assembly 12 while a second portion of assembly 12 is exposed to liquid fuel 15 in the fuel environment of fuel tank 14. Alternately, the connected electrical components and/or the wire connector assembly may all be disposed external to the fuel tank or all disposed internal to the fuel tank dependent on the electrical application of use of the wire connector assembly. As such, the second portion of assembly 12 disposed within tank 14 may be subjugated to various amounts of liquid fuel immersion, such as if tank 14 is filled to a full level of liquid fuel 15. When the second portion of assembly 12 is surrounded by fuel 15, assembly 12 is desirably impervious to leakage of liquid fuel through a connector body 20. Assembly 12 has a plurality of first wire cables 16a-d and a plurality of second wire cables 18a-d that respectively exit connector body 20 of assembly 12. When the second portion of assembly 12 is completely surrounded by fuel 15, electrical signals carried on plurality of first wire cables 16a-d are carried through the liquid fuel environment, or first environment past a boundary of connector body 20 and into, or within assembly 12 that does not contain fuel and out through wire cables 18a-d to an air environment which is a second environment distinctly different from the first environment. Alternately, the wire connector assembly is quite suitable to provide satisfactory operation in air-only environments or in non-air gaseous and/or liquid environments or in any combination of environments thereof.

Connector body 20 is an overmolded connector body that surroundingly seals at least one wire arrangement 22a-d in electrical connection with plurality of first and second wire conductors, or cables 16a-d, 18a-d. The overmolded, dielectric connector body 20 of wire connector assembly 12 is sealingly attached to an internal boundary body, or bulkhead 11 of tank 14 using O-ring seals 26. Preferably, connector body 20 may be formed from any dielectric plastic material. Alternately, the connector body may be formed from an epoxy-based dielectric material that allows chemical bonding with an insulation outer layer of the wire cables that further fluidly seals the wire connector assembly against fluid leakage entering the assembly from outside, or external to the wire connector assembly. The epoxy-based material of the connector body may provide the additional robust performance needed in a chemical or oil application so that the connector body is less likely to soften or chemically break down over a time period when disposed these in these types of applications. A breakdown of the connector body may undersirably result in a quality defect of the wire connector assembly. A defective wire connector assembly may require servicing to replace the wire connector assembly that undesirably increases service costs of the wire connector assembly. The wire connector assembly may be useful in the motorized transportation industry such as in fuel tank applications such as those that use fuel tank monitors, or in other industries like chemical processing, and oil and gas exploration. Still alternately, for aerospace or space-based applications flame retardant, low toxicity plastic materials may be utilized to construct the connector body.

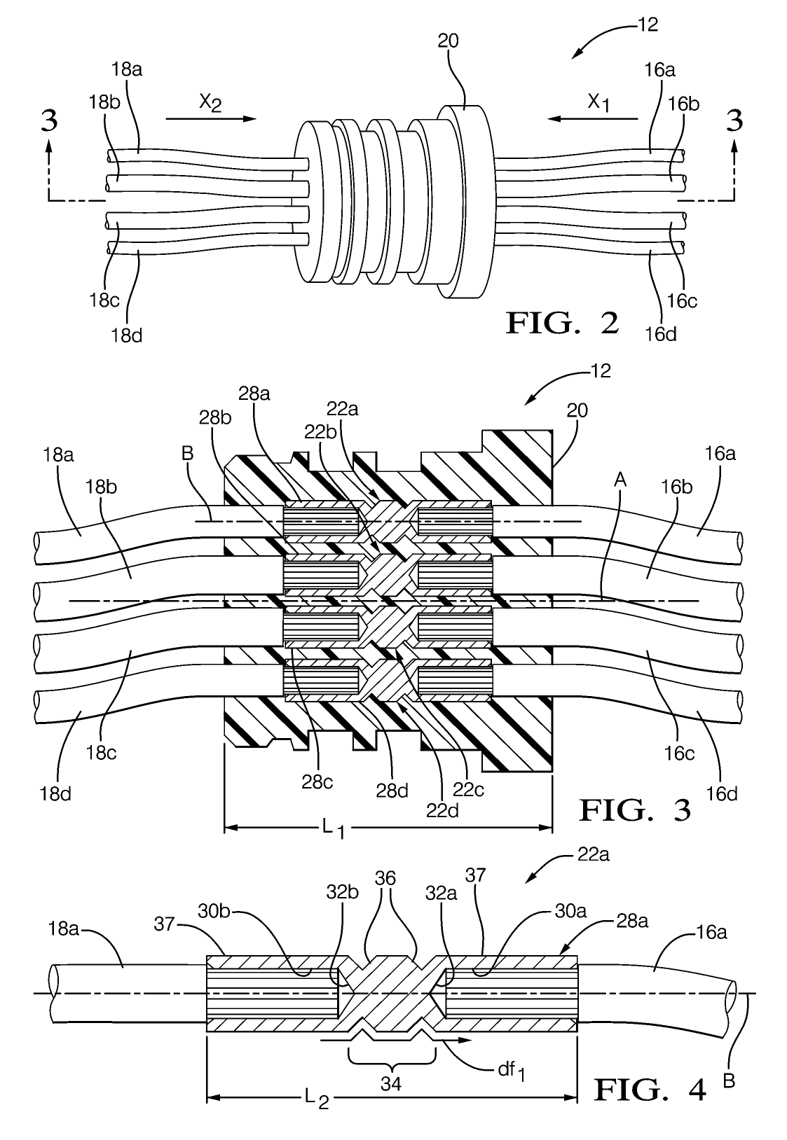

Referring to FIGS. 2 and 3, wire connector assembly 12 of FIG. 1 is removed from tank 14 of lawn mower 10. Connector body 20 has a length L₁ disposed along longitudinal axis A of connector body 20. First plurality of wire cables 16a-d and the second plurality of wire cables 18a-d axially extend away from connector body 20 in opposing directions to respectively electrically connect with other electrical circuits and/or electrical devices. First wire cables 16a-d join with connector body 20 from a first direction X₁ and second wire cables 16a-d join with connector body 20 from a second direction X₂ opposite first direction X₁.

Referring to FIG. 3, four wire arrangements 22a-d are axially disposed and include four respective electrically-conductive splice contact elements 28a-d disposed in connector body 20. Splice elements 28a-d are formed from an electrically-conductive material, such as a metal material. Preferably, the splice elements are formed from brass or steel material. A portion of first wire cables 16a-d are disposed proximate one end of splice elements 28a-d and are surroundingly enclosed by connector body 20 and a portion of second wire cables 18a-d are disposed proximate another end of splice elements 28a-d and are surroundingly enclosed by connector body 20. Splice elements 28a-d are further spaced apart one-to-another in a direction perpendicular to axis A within connector body 20 being spaced apart by portions of connector body 20, as best illustrated in FIG. 3. Thus, each wire arrangement in the plurality of wire arrangements 22a-d is electrically independent from the other wire arrangements when splice elements 28a-d are disposed in connector body 20.

Referring to FIG. 4, a single splice contact element 28a is shown removed from wire connector assembly 12 of FIG. 3. Splice element 28a is disposed along an axis B along a length L₂ of splice element 28a. Preferably, splice element 28a, has a circular shape, but may have any shape that allows for proper construction of splice element 28a. Axis B is generally parallel with axis A when splice element 28a is disposed in wire connector assembly 12 with other splice elements 28b-d, as best illustrated in FIG. 3. Splice element 28a is fabricated from a continuous solid mass of electrically-conducting material throughout. Solid mass element 28a defines an axial first bore 30a and a co-axial second bore 30b along axis B. Bores 30a, 30b may be formed by drilling. First bore 30a is drilled to have closed end 32a and second bore 30b is also drilled to have closed end 32b similar to closed end 32a. The closed ends of bores 30a, 30b have a tapered end as a result of the drill bit used to form bores 30a, 30b. Alternately, the closed ends of the bores may have a shape different than the tapered end. The diameter size of bore 30a is about a same diameter size as a diameter size of bore 30b. Alternately, the bores may each have a different diameter size to accommodate different sized wire cables that may be required in some electrical applicatons in which the wire connector assembly is disposed. Bores 30a, 30b are axially drilled in a manner so that a section, or portion of solid mass element 34 axially separates first bore 30a from second bore 30b along axis B. Solid mass portion 34 is centrally disposed on splice element 28a along a length L₂ of splice element 28a.

Splice element 28a further includes at least one detent feature, or circumferential groove 36 defined in an external surface 37 of splice element 28a along solid mass portion 34 along length L₂ of splice element 28a. Groove 36 surrounds axis B and is preferably V-shaped. Alternately, the groove may have any shape. When connector body 20 is overmolded on splice element 28a, material of connector body 20 flows in to grooves 36 which subsequently allows splice element 28a to mechanically grip connector body 20 and secure splice element 28a and connector body 20 together. Alternately, if the connector body is formed of a dielectric, epoxy-based material, a mechanical adhesion of the connector body to the splice element may also occur that may also further enhance the mechanical strength of the wire connector assembly. Still yet alternately, the at least one detent feature may be formed as raised portions that extend away from the external surface of the splice contact element. External surface 37 is a generally smooth surface that may contain machining marks due to forming of splice element 28a. Alternately, the external surface of the splice element may be a polished surface or a knurled surface.

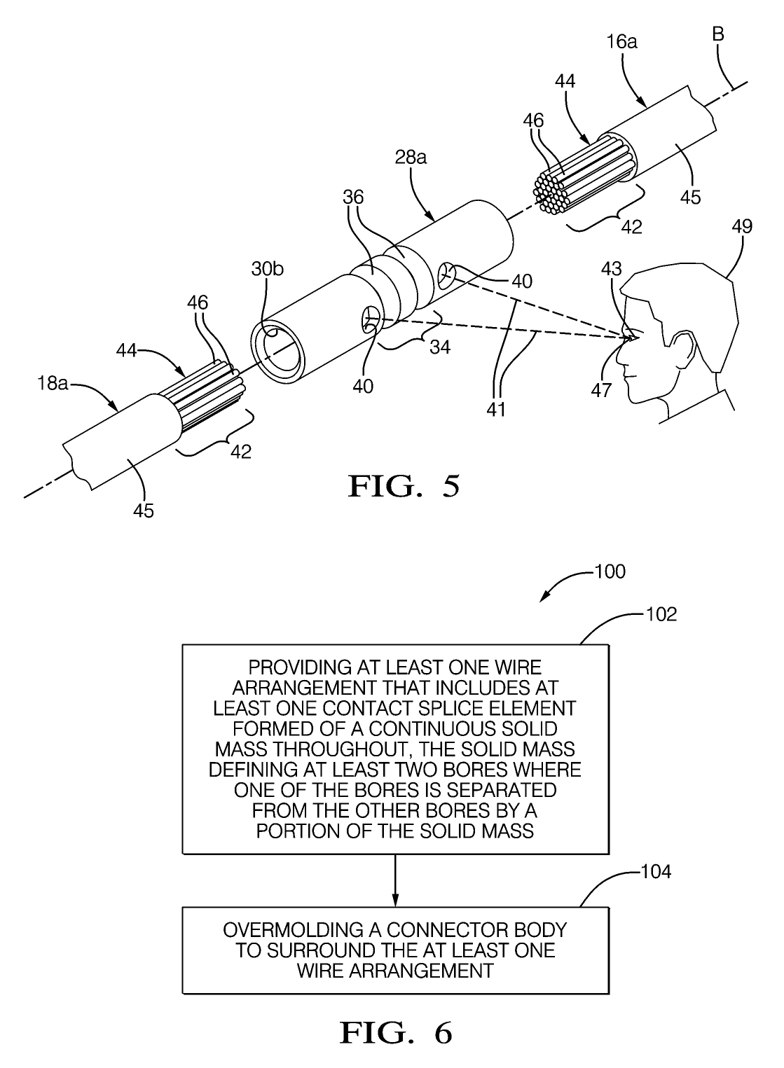

Referring to FIGS. 4 and 5, an exploded view of the wire cables 16a, 16b and splice element 28a shows first and second wire cable 16a, 18a being respectively inserted towards, and received by respective bores 30a, 30b along axis B of splice contact element 28a. Splice element 28a contains a respective apertures, or viewing ports 40 therethrough in communication with each of bores 30a, 30b disposed adjacent closed ends 32a, 32b. Viewing ports 40 desirably allow for visual inspection along viewing lines 41 by an eye 43 of a human assembly operator 49 of respective leads 42 of wire cables 16a, 18a in bores 30a, 30b from a fixed point 47. This ensures leads 42 are inserted to a depth in bores 30a, 30b that is adjacent tapered closed ends 32a, 32b, as best illustrated in FIG. 4, that advantageously ensures a high quality electrical and mechanical connection of leads 42 to splice element 28a. Leads 42 may be inserted in bores 30a, 30b manually by human assembly operator 49 when at least one wire arrangement 22a is manually constructed. At least one wire arrangement 22a is formed when respective leads 42, being an extension of an inner metallic core 44 of wire cables 16a, 18a, are electrically and mechanically attached to splice contact element 28a, such as by crimping, as is known in the wiring arts. The crimp may be applied by a crimping press as is also known in the crimping arts. Inner wire core 44 of wire cables 16a, 18a is surrounded by a respective insulation outer layer 45. Preferably, inner wire core 44 is formed of a plurality of individual wire strands 46. Wire strands 46 advantageously allow wire cables 16, 18 to bend at an interface with connector body 20 without wire cable breakage that overcomes the drawback of the tinned wire strands on conventional feed-through members cited in the Background as previously described herein. Alternately, the inner wire core may be formed of a single continuous solid wire strand of electrically-conductive material. In one non-limiting embodiment, the wire cables having the inner core formed of individual wire strands may a bend of up to ninety (90) degrees, or be about transverse to the interface with the connector body along the external surface of the connector body. Alternately, the inner wire core may be formed of a solid metallic material. In another non-limiting embodiment, the insulation outer layer is formed of a dielectric, polytetrafluorethylene (PTFE) material that may be useful in hot temperature environments where the wire connector assembly may be employed. If the connector body is formed from an epoxy material, the connector body does not chemically bond to the PTFE insulation outer layers, but still has a robust performance in the high temp environment in that the PTFE material may not melt or soften with exposure to the hot temperatures that may otherwise undesirably affect the electrical performance of electrical devices in electrical communication with the wire connector assembly. The remaining splice contact elements 28b-d are constructed similarly to that of splice contact element 28a, as previous discussed herein. Alternately, the at least one wire arrangement may be manufactured on an automated assembly line.

Referring to FIG. 6, a method 100 to construct wire cable assembly 12 is presented. One step 102 in method 100 includes a step of providing at least one wire arrangement 22a-d. Wire arrangement 22a-d includes at least one splice contact element 28a-d and at least two wire cables 16a-d, 18a-d. Another step 104 in method 100 includes overmolding connector body 20 to surround the at least one wire arrangement 22a-d.

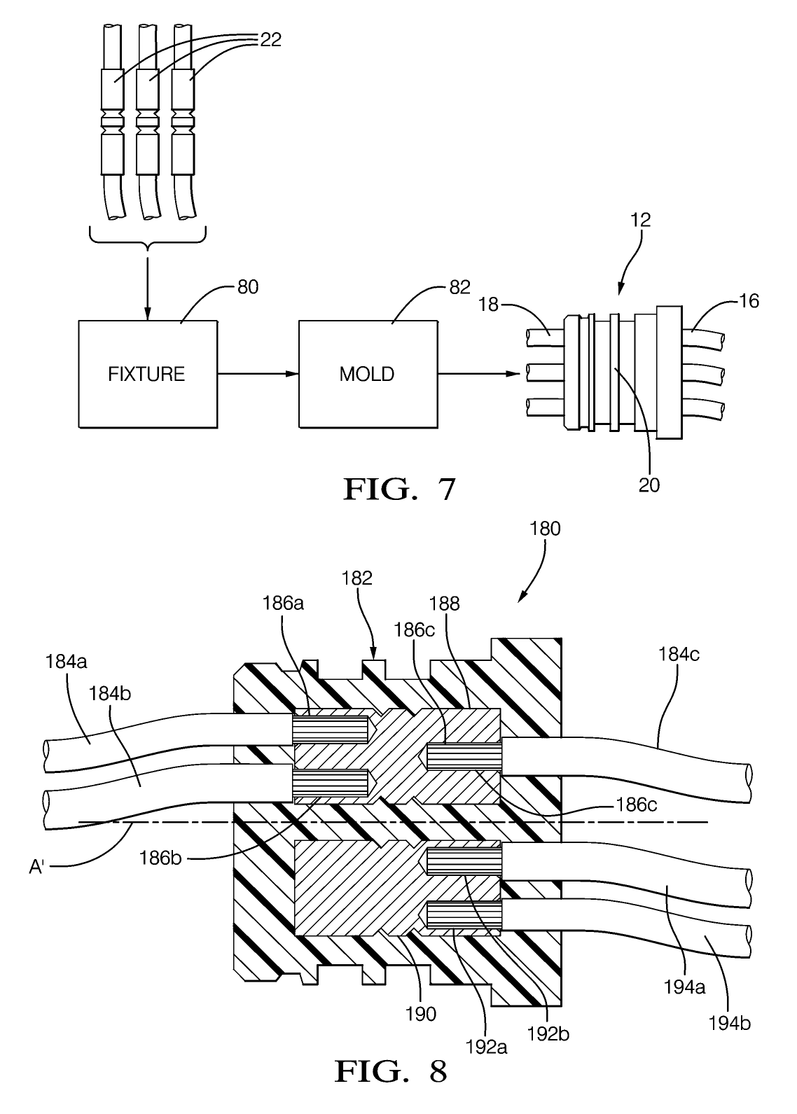

Referring to FIGS. 6 and 7, prior the step 104, a further substep of forming at least one detent 37 is undertaken. Circumferential V-shaped grooves 37 may be machined in an external surface 37 of element 28. Alternately, the grooves may be stamped or cold formed by a press as is known in the art. Also prior to step 104, another substep of aligning plurality of splice contact elements 28a-d in a fixture 80 ensures that each splice element 28 is electrically independent from the other splice elements so that after overmolding step 104 is completed, the electrical independence of splice elements 28a-d is maintained. If the electrical independence is not maintained an undesired quality defect may occur, as one splice contact element may electrically short to an adjoining splice contact element.

When operating in these gaseous and/or liquid environments, such as when disposed at least partially in fuel tank 14 of lawn mower 10 as best illustrated in FIG. 1, assembly 12 includes features that further prevent non-air gas or fluid leakage through assembly 12. The robustness of assembly 12 to retard undesired fluid or gaseous leakage is measured through a fluid leak test that includes an applied air pressure test through portions of assembly 12. One such air pressure test applies a ten (10) pound per square inch (psi) axial pressure test to each wire arrangement disposed in the wire connector assembly. Under applied air pressure, no pressurized air should exit at any point along the exterior surface of connector body 20. Air may be inserted into a wire conductor along the boundary of the connector body, such as where the wire conductors enter the connector body, and using the eyes of a human operator, visually inspect if air bubbles emit from another portion of the connector body. Alternately, a vacuum test may also detect if air is pulled through a developed leak path in the connector body or wire assembly. A defective wire connector assembly is one that exhibits at least one leak path through the connector body as a result of the applied air. Thus, a defective wire conductor assembly is one where air fluid is observed to exit any portion of connector body 20 along the external surface of connector body 20 from where the pressurized air is initially applied. Alternately, a pressure vacuum fluid leak test may be utilized which is also an air-type test.

The fluid leak test may produce three types of possible leak paths in wire connector assembly 12. A first fluid leak path through assembly 12 is along external surface 37 from one axial end of splice element 28 towards the other axial end of the splice element 28a. Should a void be present at an interface of connector body 20 and at least one of the wire cables 16, 18, the first fluid leak path may commence through wire connector assembly 12. One of the grooves 36 advantageously provides a discontinuity, or disruptive flow path df₁ along external surface 37 to mitigate the flow of the leaking fluid in the first fluid leak path, as best illustrated in FIG. 4. Preferably, two circumferential grooves 36 provide the redundancy necessary to prevent fluid flow along external surface 37. It has been observed if leaking fluid flows along external surface 37 past one of the grooves 36, the other groove 36 prevents further fluid leakage along external surface 37 beyond the other groove 36. A second leak path may occur through view ports 40 or along inner wire core 44 of wire conductors 16a, 18a. A third leak path is prevented along an external surface of connector body 20 by using O-ring seals 26 that sealingly engage against bulkhead 11 of fuel tank 14 when connector body 20 is inserted in bulkhead 11, as best illustrated in FIG. 1. The level of sealing of the O-ring is dependent on a sufficiently sized grooves defined in the connector body to procure the needed sealing capability. Solid mass portion 34, being formed from the continuous solid mass of material consistent with splice element 28a throughout, prevents any further fluid flow through splice element 28a or wire assembly 12. The leak paths and fluid leak test, as discussed above, are also applicable to splice elements 28b-d in connector body 20.

Wire connector assembly 12 is not in use when splice elements 28a-d have not received wire conductors 16a-d, 18a-d and connector body 20 is not molded to surround splice elements 28a-d to form wire connector assembly 12. Assembly 12 is also not in use if not electrically connected in an electrical application.

Assembly 12 is in use when splice elements 28a-d have received wire conductors 16a-d, 18a-d that are attached thereto, and connector body 20 surrounds elements 28a-d and a portion of wire cables 16a-d, 18a-d adjacent connector body 20 along with assembly 12 being properly electrically connected in an electrical application.

Referring to FIG. 7, arrangements 22a-d are arranged in fixture 80 prior to fixture 80 being moved to a mold machine 82 so that connector body 20 is molded thereto. Any type of plastic injection mold machine as known in the molding arts may be used to mold connector body 20. Once connector body 20 is overmolded in mold machine 82 to produce wire connector assembly 12, arrangements 22a-d have an arrangement in assembly 12 that is about a same arrangement as was arranged on fixture 80 prior to moving fixture 80 in to mold machine 82. The fixture is formed from a steel or aluminum material. Grooves 36 are advantageous for aligning the arrangements 22a-d in fixture 80. Grooves 36 also allow arrangements 22a-d to be sufficiently secured to connector body 20 that allows external surface 37 to be a generally smooth surface as previously described herein. Alternately, a textured external surface or a knurled external surface of the splice element may yet further enhance the mechanical securement of the connector body and the splice elements together in the wire connector assembly.

Referring to FIG. 8, according to an alternate embodiment of the invention, other bore arrangements in contrast to the co-axial bore arrangement in splice element 22a of the embodiment of FIG. 4 are presented. A wire connector assembly 180 includes a connector body 182 and splice elements 188, 190 that show a pair of different configurations for plurality of wire conductors 184, 194 disposed in splice elements 188, 190. Wire conductors 184, 194 are in electrical and mechanical connection with respective splice elements 188, 190 similar to wire cables 16, 18 in assembly 12 in the embodiment of FIG. 3. Splice element 188 receives leads 186a, 186b, 186c of three wire cables 184a, 184b, 184c and splice element 190 received leads 192a, 192b of wire cables 194a, 194b. Connector body 182 surrounds elements 188, 190 and portions of wire cables 184a, 184b, 184c, 194a, 194b adjacent splice elements 188, 190. Splice elements 188, 190 are arranged in connector body 182 so as to be electrically independent one-to-another within connector body 20. As such, portions of dielectric connector body 20 surround each individual splice element 188, 190 to ensure the electrical independence of splice elements 188, 190. Splice element 188 has a wire arrangement in which two wire conductors 184a, 184b are axially spaced apart by portion of solid mass material of splice element 188 from wire cable 184c along axis A′. Splice elements 188, 190 and connector body 180 are formed from similar materials and constructed in similar fashion as splice element 22 and connector body 20 as described in the embodiment of FIG. 3.

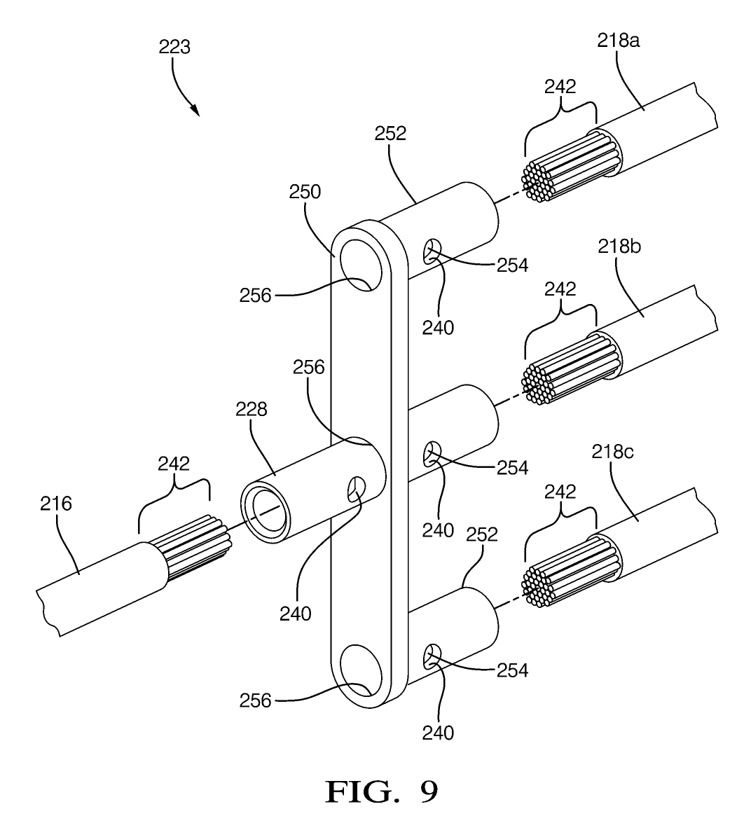

Referring to FIG. 9, according to another alternate embodiment of the invention, a wire connector assembly 223 includes at least one splice contact element 228 and at least one secondary splice element 252 that are respectively electrically and mechanically attached to an electrically-conducting bus bar 250 that forms a one-to-many electrical signal distribution node. Elements in FIG. 8 that are similar to elements in the embodiment of FIGS. 1-5 have reference numerals that differ by 200. Secondary splice elements 252 include a single bore 254 defined in each secondary splice element 252. Bus bar 250 and splice elements 228, 252 are formed of similar electrically-conducting material as splice element 12 described in the embodiment of FIGS. 1-5 previously described herein. View ports 240 are disposed in splice elements 252 and provide a similar advantage aperture 40 in the embodiment of FIGS. 1-5. Namely, view ports 240 face towards one side to simplify visual inspection of the leads of the wire conductors attached to splice element 228. One way of attachment, not by way of limitation, is for splice elements 228, 250 to attach to bus bar 250 by a press, or force fit in the respective holes 256 defined in bus bar 250. Alternately, soldering may be used to attach the splice elements to the bus bar. Assembly 223 includes splice elements 228, 252 and the associated wire arrangements along with bus bar 250 being surroundingly overmolded with a connector body (not shown) similar to the connector body associated with assembly 12 in the embodiment of FIG. 2.

Alternately, the splice elements may be attached to the bus bar by soldering or welding or a combination of press-fitting/welding/soldering as may be required for an electrical application of use. A single first wire cable 216 is received in one of the bores of splice contact element 228 and a plurality of second wire cables 218a-c respectively received in other bores of splice elements 228, 252. Alternately, a plurality of splice elements of the type described in the embodiment of FIGS. 1-5 may be attached to the bus bar. Thus, bores not receiving leads of wire cables remain unfilled. The number of bores filled with the leads of wire cables is dependent on the electrical application of the use of the wire conductor assembly having the electrical bus bar. In yet another embodiment, a plurality of first and second wire cables may be attached to the corresponding splice elements. Regardless of the configuration, the electrical bus bar and corresponding splice elements would be covered by an overmolded connector body (not shown) constructed around splice elements 228, 252 and bus bar 250 in a similar fashion to splice elements 28a-d in the embodiment of FIGS. 1-5. Still yet alternately, secondary splice elements including the one bore may include a head portion formed slightly larger than the hole in the bus bar to be snap-fit with a force fit through the hole to further secure the one bore contact element to the electrical bus bar. The groves of the splice element 228 are hidden by the electrical bus bar.

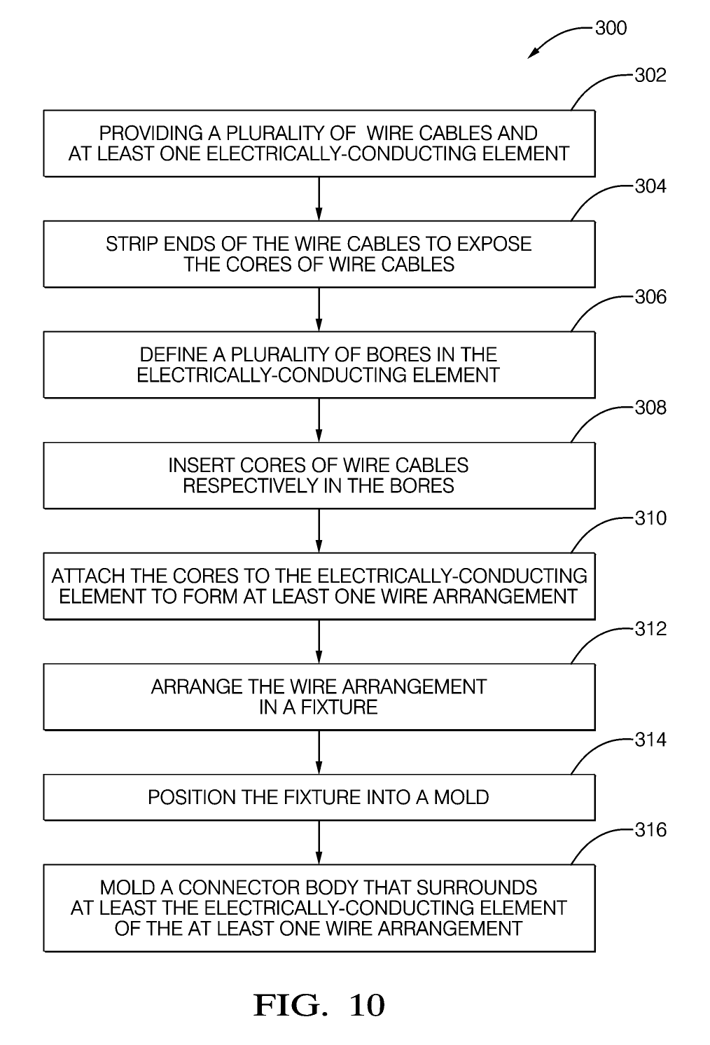

Referring to FIG. 10, according to yet another embodiment of the invention, a method 300 is presented to fabricate wire connector assembly 12. One step 302 in the method 300 is providing a plurality of wire cables 16a-d and at least one splice contact element 28a-d formed from a continuous solid mass of material throughout. Another step 304 in method 300 is respectively striping respective ends of the plurality of wire cables 16a-d, 18a-d to expose leads 42 of the plurality of wire cables 16a-d, 18a-d. A further step 306 in method 300 is defining at plurality of bores 30a, 30b in the solid mass element 28a-d. A further step 308 of method 300 is inserting leads 42 of plurality of wire cables 16a-d, 18a-d respectively in plurality of bores 30a, 30b. Another step 310 in method 300 is electrically and mechanically attaching leads 42 of plurality of wire cables 16a-d, 18a-d and solid mass elements 28a-d together by a crimp, as previous discussed herein, to form at least one wire arrangement 22a-d. When at least one wire arrangement is a plurality of wire arrangements 22a-d, a further step 312 in method 300 is arranging plurality of wire arrangements 22a-d in fixture 80 prior to injection molding step 316 so that after injection mold step 316 is performed respective wire arrangements in the plurality of wire arrangements 22a-d surrounded by molded connector body 20 are electrically independent one-to-another. Another step 314 in method 300 is positioning fixture 80 with the arranged arrangements 22a-d in mold 82 prior to injection molding step 316. Step 316 in method 300 is injection molding connector body 20 to surround at least the splice elements 28a-d. Other steps in the method may include mechanical and visual inspection of the molded wire connector assembly. One inspection may include inspecting the lead of a wire cable and ensuring the wire cable is fully seated in the bore as visually seen through the inspection hole of the wire arrangement. The fluid leak test as previously described herein is used to validate that the wire connector assembly exhibits no fluid leaks. A further step may include a final visual quality inspection used to inspect the molded wire connector assemblies. This quality inspection may include, but is not limited to inspection for undesired quality items such as flash, wire orientation, and/or other damage to the wire connector assembly.

Alternately, the connector body may be molded with a visually clear type of material to further enhance visualization of leak paths through the connector body should they occur.

Alternately, any type of configuration of wire arrangements may be employed with the connector body. This may include, but is not limited to an array of wire arrangements within the connector body. One type of wire arrangement array may be rows of wire arrangements overlying other rows of arrangements. Another type of arrangement may be a staggered row arrangement. The fixture would be constructed in a manner to produce the needed configuration. In yet another wire arrangement configuration may include an array of wire arrangements in combination with an electrical bus bar configuration as previously described herein.

While a number of bore arrangements have been discussed herein, any type of bore arrangement may be employed with any number of bores and still be within the spirit and scope of the invention.

Thus, a robust wire connector assembly has been presented that operates in fluid environments. The wire connector assembly provides electrical conductivity of the wire cables end-to-end through the connector body of the assembly in air-only environments, non-air environments, or liquid fluid environments, or a combination of environments thereof. The wire connector assembly ensures there is no fluid leakage through the inner core wire strands because the splice element contains a central, solid portion that separates the bores so that fluid leakage is prevented. The wire connector assembly uses no solder in its construction, thus, there is no undesired wicking of solder as previously described in the Background. The core of the wire cable having individual wire strands provide optimum flexibility of the wire cables exiting the connector body for even right-angle bends adjacent an external surface of the connector body if this type of configuration is required in specific electrical applications. This increased flexibility of the individual wire stands beyond the molded connector body enable tight wire routing and bend radii of the wire cables. The wire strands prevent premature electrical breaking of the inner core of the wire cables in contrast to that of the tinned wires as described in the Background. A connector body formed from the epoxy-based material may exhibit mechanical bonding to the splice elements and chemical bonding to the insulation outer layer of the wire cables which may provide additional protection and decreased risk of fluid leakage through the wire connector assembly. If fluid flow does occur along an external surface of the splice element, a first and a second circumferential groove disposed along the solid mass portion are spaced apart along a portion of the splice element to prevent fluid flow along the external surface. If fluid flow occurs through the wire strands of the wire conductors or the view ports of the splice element, the solid mass portion prevents further fluid flow through the splice element. If fluid flow travels along an external surface of the connector body, the O-ring seals retard further fluid flow movement. The wire conductors may further include an insulation outer layer formed of a dielectic, polytetrafluorethylene (PTFE) material that may be useful in hot temperature environments where the wire connector assembly may be employed. One type of wire connector assembly may include wire conductors coaxially disposed in the splice element that is advantageous in certain electrical applications. Other non-coaxial arrangements may be produced that provide advantageous in other types of electrical configurations where the wire connector assembly may be used. A wire conductor assembly may be produced that is has a multitude of wire arrangement configurations including arrayed wire arrangement configurations dependent on the electrical application of use for the wire connector assembly. In addition to the grooves defined in the splice element preventing fluid flow through the wire connector assembly, the grooves also advantageously provide the means for alignment of the wire arrangements that include the splice elements in a fixture prior to molding of the connector body and may further reduce manufacturing costs of the wire connector assembly as the external surface of the splice elements may not need to be further textured or knurled to ensure a reliable mechanical connection between the connector body and the splice elements.

While this invention has been described in terms of the preferred embodiment thereof, it is not intended to be so limited, but rather only to the extent set forth in the claims that follow.

It will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

We claim:

1. A wire connector assembly comprising:
a connector body; and
at least one wire arrangement in communication with the connector body, the wire arrangement including,
at least one electrically-conductive element formed of a continuous solid mass of material throughout, said at least one solid mass element defines a plurality of bores in which at least a portion of said solid mass element separates at least one of the bores from the other bores in the plurality of bores, and
a plurality of wire cables respectively received in the plurality of bores and electrically and mechanically connected to said solid mass element.

2. The wire connector assembly according to claim 1, wherein when the wire connector assembly is disposed in a fluid environment the wire connector assembly is impervious to leakage of fluid therethrough.

3. The wire conductor assembly according to claim 1, wherein the connector body is formed of a dielectric material and the plurality of wire cables respectively include an electrically-conductive inner core surrounded by an insulation outer covering in which a portion of the insulation outer covering is removed to expose a lead, and the leads of the plurality of wire cables are received by said solid mass element, and the connector body enclosingly surrounds said solid mass element and the insulation outer coverings of the plurality of wire cables at least adjacent to the leads, and said inner core comprises individual wire strands.

4. The wire conductor assembly according to claim 1, wherein the at least one wire arrangement includes a plurality of wire arrangements being arranged in the connector body so that the plurality of wire arrangements are respectively electrically independent one-to-another.

5. The wire connector assembly according to claim 1, wherein said solid mass element includes an external surface and at least one detent feature is disposed along the external surface.

6. The wire connector assembly according to claim 5, wherein said solid mass element has a length disposed along a longitudinal axis and the at least one detent feature surrounds the axis and is disposed along said portion that separates at least one of the bores from the other bores in the plurality of bores.

7. The wire connector assembly according to claim 6, wherein the at least one detent feature comprises at least one V-shaped groove defined in said portion.

8. The wire conductor assembly according to claim 1, wherein said solid mass element has a length disposed along a longitudinal axis and the plurality of bores are co-axially defined therein.

9. The wire conductor assembly according to claim 1, wherein said solid mass element includes respective closed ends for the plurality of bores and defines respective viewing ports in communication with the plurality of bores so that when the plurality of bores receive leads of the plurality of wire cables, the respective leads are simultaneously viewable through the respective viewing ports from a fixed reference point.

10. The wire connector assembly according to claim 1, further including,
an electrical bus bar having said solid mass element being electrically attached thereto,
wherein the electrical bus bar and the solid mass element respectively communicate with the connector body.

11. A method to construct a wire connector assembly, comprising:
providing at least one wire arrangement, and the wire arrangement includes,
at least one electrically-conductive element formed of a continuous solid mass of material throughout, said at least one solid mass element defines a plurality of bores in which at least a portion of said solid mass element separates at least one of the bores from the other bores in the plurality of bores, and
a plurality of wire cables respectively received in the plurality of bores and electrically and mechanically connected to said solid mass element; and
overmolding a connector body to enclosingly surround with said solid mass element and the plurality of wire cables adjacent to said solid mass element.

12. The method according to claim 11, wherein when the wire connector assembly is disposed in a fluid environment said wire connector assembly is impervious to leakage of fluid therethrough.

13. The method according to claim 11, wherein said solid mass element has an external surface and a length and the length is disposed along a longitudinal axis, and the step of providing the at least one wire arrangement further includes,
forming at least one detent feature along the external surface along the length of the solid mass element so the at least one detent feature surrounds the axis prior to the overmolding step.

14. The method according to claim 11, wherein said at least one solid mass element includes a plurality of solid mass elements, and the method further includes,
positioning the plurality of solid mass elements in a manner so that each solid mass element is electrically independent from the other solid mass elements in the plurality of solid mass elements prior to the overmolding step, so that after said overmolding step, said electrical independence of the respective solid mass elements in the plurality of solid mass elements surrounded by the overmolded connector body is maintained.

15. The method according to claim 11, wherein each bore in the plurality of bores has a closed end and said solid mass portion defines a viewing port in communication with each bore disposed adjacent to the closed end.

16. The method according to claim 15, wherein the providing step further includes,
simultaneously viewing leads of the plurality of wire conductors received in the plurality of bores through the respective viewing ports from a fixed referance point.

17. A method to fabricate a wire connector assembly, comprising:
providing a plurality of wire cables and at least one electrically-conductive element formed from a continuous solid mass of material throughout;
respectively striping respective ends of the plurality of wire cables to expose electrically-conductive cores of the plurality of wire cables;
defining at plurality of bores in said solid mass element;
inserting the electrically-conductive cores of the plurality of wire cables in the plurality of bores;
electrically and mechanically attaching the plurality of cores to said solid mass element to form at least one wire arrangement; and
injection molding a connector body in a mold to surround the at least one wire arrangement to form the wire connector assembly.

18. The method of claim 17, further including,
performing a fluid leak test on the wire connector assembly so that when the wire connector assembly is disposed in a fluid environment and tested with the fluid leak test the tested wire connector assembly is impervious to leakage of fluid therethrough.

19. The method of claim 17, wherein the at least one wire arrangement comprises a plurality of wire arrangements, and the method further includes,
arranging the plurality of wire arrangements on a fixture prior to the injection molding step so that after the injection mold step is performed, the plurality of wire arrangements surrounded by the molded connector body are electrically independent one-to-another, and
positioning the arranged plurality of wire arrangements in the mold prior to the injection molding step.

20. The method of claim 19, wherein said arranged plurality of wire arrangements and the formed wire connector assembly after the overmolding step have about a same arrangement of the plurality of wire arrangements, and said cores comprise a plurality of individual wire strands.
